(19) United States
(12) Patent Application Publication
(10) Pub. No.: US 2021/0362490 A1
(43) Pub. Date: Nov. 25, 2021

(54) ZONE-BASED FIRING SIGNAL ADJUSTMENT

(71) Applicant: Hewlett-Packard Development Company, L.P., Spring, TX (US)

(72) Inventors: Eric Martin, Corvallis, OR (US); Daryl E. Anderson, Corvallis, OR (US)

(73) Assignee: Hewlett-Packard Development Company, L.P., Spring, TX (US)

(21) Appl. No.: 17/045,516

(22) PCT Filed: Jun. 11, 2018
(86) PCT No.: PCT/US2018/036897

§ 371 Date: Oct. 6, 2020

(51) Int. Cl. B41J 2/045; B41J 2/195

(52) U.S. Cl. CPC B41J 2/04563; B41J 2/04598; B41J 2/195; B41J 2/0454; B41J 2/04573

(57) ABSTRACT

In one example in accordance with the present disclosure, a fluidic die is described. The fluidic die includes a number of zones. Each zone includes a number of sets, each set including a number of fluidic devices. Each fluidic device includes a fluid chamber and a fluid actuator disposed in the chamber. Each fluidic device also includes a sensor to sense a characteristic of the zone and a register to hold an adjustment value that indicates how much to adjust a firing signal in the zone. A delay device per set delays the firing signal at a corresponding set. An adjustment device per set generates an adjusted firing signal based on the adjustment value, a delayed firing signal corresponding to the set, and at least one delayed firing signal received from another set. The delayed firing signals from different sets are time shifted relative to one another.

### BACKGROUND

A fluidic die may be a component of a fluidic system. The fluidic die includes components that manipulate fluid flowing through the system. For example, a fluidic ejection die, which is an example of a fluidic die, includes a number of nozzles that eject fluid. The fluidic die also includes non-ejecting actuators such as micro-recirculation pumps that move fluid through the fluidic die. Through these nozzles and pumps, fluid, such as ink and fusing agent among others, is ejected or moved.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a fluidic die for zone-based firing signal adjustment, according to an example of the principles described herein.

FIG. 2 is a block diagram of a delay device for zone-based firing signal adjustment, according to an example of the principles described herein.

FIG. 3 is a block diagram of an adjustment device for zone-based firing signal adjustment, according to an example of the principles described herein.

FIGS. 4A-4C are schematic diagrams of a fluidic system for zone-based firing signal adjustment, according to an example of the principles described herein.

FIG. 5 is a schematic diagram of a fluidic system for zone-based firing signal adjustment, according to an example of the principles described herein.

FIG. 6 is a schematic diagram of an adjustment element for zone-based firing signal adjustment, according to an example of the principles described herein.

FIG. 7 is a flow chart of a method for zone-based firing signal adjustment, according to an example of the principles described herein.

FIG. 8 is an example of generated adjusted firing signals, according to an example of the principles described herein.

FIG. 9 is an example of generated adjusted firing pulses, according to an example of the principles described herein.

FIG. 10 is a flow chart of a method for zone-based firing signal adjustment, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Fluidic dies, as used herein, may describe a variety of types of integrated devices with which small volumes of fluid (e.g., milliliters, microliters, picoliters, etc.) may be pumped, mixed, analyzed, ejected, etc. Such fluidic dies may include ejection dies, such as those found in printers, additive manufacturing distributor components, digital titration components, and/or other such devices with which volumes of fluid may be selectively and controllably ejected.

In a specific example, these fluidic die are found in any number of printing devices such as inkjet printers, multi-function printers (MFPs), and additive manufacturing apparatuses. The fluidic systems in these devices are used for precisely, and rapidly, dispensing small volumes of fluid. For example, in an additive manufacturing apparatus, the fluid ejection system dispenses fusing agent and/or detailing agent. The fusing agent is deposited on a build material, which fusing agent facilitates the hardening of build material to form a three-dimensional product, The detailing agent may be used to more precisely define the boundaries between fused regions and unfused regions.

Other fluid systems dispense ink on a two-dimensional print medium such as paper. For example, during inkjet printing, fluid is directed to a fluid ejection die. Depending on the content to be printed, the device in which the fluid ejection system is disposed determines the time and position at which the ink drops are to be released/ejected onto the print medium. In this way, the fluid ejection die releases multiple ink drops over a predefined area to produce a representation of the image content to be printed. Besides paper, other forms of print media may also be used.

Accordingly, as has been described, the systems and methods described herein may be implemented in a two-dimensional printing, i.e., depositing fluid on a substrate, and in three-dimensional printing, i.e., depositing a fusing agent or other functional agent on a material base to form a three-dimensional printed product.

Each fluidic die includes a fluid actuator to eject/move fluid. In a fluidic ejection die, a fluid actuator may be disposed in an ejection chamber, which chamber is coupled to an opening, which may be referred to as a nozzle. The fluid actuator in this case may be referred to as an ejector that, upon actuation, causes ejection of a fluid drop via the opening.

Fluid actuators may also be pumps. For example, some fluidic dies include microfluidic channels. A microfluidic channel is a channel of sufficiently small size (e.g., of nanometer sized scale, micrometer sized scale, millimeter sized scale, etc.) to facilitate conveyance of small volumes of fluid (e.g., picoliter scale, nanoliter scale, microliter scale, milliliter scale, etc.). Fluidic actuators may be disposed within these channels which, upon activation, may generate fluid displacement in the microfluidic channel.

Examples of fluid actuators include a piezoelectric membrane based actuator, a thermal resistor based actuator, an electrostatic membrane actuator, a mechanical/impact driven membrane actuator, a magneto-strictive drive actuator, or other such elements that may cause displacement of fluid responsive to electrical actuation. A fluidic die may include a plurality of fluid actuators, which may be referred to as an array of fluid actuators.

While such fluidic systems and fluidic dies undoubtedly have advanced the field of precise fluid delivery, some conditions impact their effectiveness. For example, the thermal state of the fluidic die may affect how fluid is ejected from a fluidic die. For example, at locations where the fluidic die is warmer, the relationship between drop weight and fire pulse energy changes. That is, under one set of temperature conditions, a firing pulse having certain characteristics will generate fluid drops having a particular weight. Under different temperature conditions that same firing pulse will generate fluid drops having a different weight. In some examples, different drop weights may affect the appearance in two-dimensional printing. For example, the different drop weights result in difference in fluid saturation, which in 2D printing can manifest itself with light color areas on certain parts of the printed output and darker color areas on other areas of the printed output.

A thermal gradient can be formed across a fluidic die. For example, as the circuitry and other components of a fluidic die operate to manipulate fluid, heat is generated and absorbed by the substrate on which the components are disposed. In other words, the natural operation of the fluidic die generates heat, which heat can have a negative impact on print quality or in general, the consistency of fluidic manipulation. In some cases, localized thermal gradients of up to approximately 15 degrees Celsius can exist across a fluidic die.

Note that while specific reference is made to a thermal profile affecting drop weight, any number of other die characteristics may affect the drop weight. For example, the fluidic die may see a parasitic drop across a power distribution network, which similarly generates a gradient across the fluidic die that may affect localized drop weights,

As yet another example, fluid characteristics, such as viscosity can affect drop ejection and drop tail break up. Both of these characteristics can affect drop velocity and drop weight. In this example a refill curve of a drop bubble formation cycle can measure how quickly fluid flows back into a fluid chamber. This refill curve is a function of the viscosity.

As yet another example, over time, actuators may wear out non-uniformly. The wearing out of an actuator may affect its performance so as to cause drop variation.

Accordingly, the present specification describes a fluidic die and fluidic system that account for such thermal (and other) gradients that can varying drop weights. That is, the present system locally modulates firing signals based on local thermal, or other sensed characteristics of the die.

Specifically, a fluidic die is divided into zones, with each zone including a set of fluidic devices and a sensor. Using the specific example of thermal sensing, a temperature sensor detects a temperature of the zone. A controller of the system determines an amount that the firing signal in that zone should be adjusted based on the output of the temperature sensor, and adjusts the firing signal accordingly. Such an operation is carried out for each zone. In other words, the firing signal is adjusted per zone, such that the thermal characteristics of each zone are addressed individually, thus countering the effects of the thermal state of that zone.

In this specification, each thermal zone's firing energy is adjusted absolutely relative to a nominal firing signal, rather than relative to a preceding zone's firing signal. That is, each thermal zone's firing energy is set independently based on an absolute temperature. This is done by using locally delayed firing signals from subsequent and preceding sets to extend/truncate the firing signal in the thermal zone being adjusted,

Specifically, the present specification describes a fluidic die. The fluidic die includes a number of zones. Each zone includes a number of sets, each set including a number of fluidic devices. A fluidic device includes a fluid chamber and a fluid actuator disposed in the fluid chamber. Each zone also includes 1) a sensor to sense a characteristic of the zone and 2) a register to hold an adjustment value which indicates how much to adjust a firing signal in the zone, Each zone also includes a delay device per set to delay the firing signal at a corresponding set. An adjustment device per set generates an adjusted firing signal based on 1) the adjustment value, 2) a delayed fire signal corresponding to the set, and 3) at least one delayed fire signal received from another set. In this example, delayed fire signals from other sets are time-shifted relative to one another.

The present specification also describes a fluidic system. The fluidic system includes the fluidic die and a controller. The controller is coupled to temperature sensors and registers for multiple zones on the fluidic die and determines the adjustment value for each zone.

The present specification also describes a method. According to the method, an incoming firing signal is delayed at a delay device associated with a set which set has multiple fluidic devices. The delayed firing signal is passed to multiple other sets, and delayed firing signals from other sets are received at the set. An adjustment device for the set then generates an adjusted firing signal based on 1) an adjustment value, 2) a delayed firing signal corresponding to the set, and 3) at least one delayed firing signal from the other wets, wherein delayed firing signals from different sets are time-shifted relative to one another,

In summary, using such a fluidic die 1) provides for the identification of any characteristic gradient that may exist across the fluidic die; 2) compensates for the characteristic gradient, or any offset from a base value, based on localized sensing systems; 3) relies on simple operations to determine an adjustment value; 4) enables parallel sensing and adjustment; 5) occupies a small circuit area; 6) provides self-contained thermal accommodation; and 7) is relatively low cost, However, the devices disclosed herein may address other matters and deficiencies in a number of technical areas.

As used in the present specification and in the appended claims, the term “fluidic die” refers to a component of a fluidic system that includes a number of fluid actuators. A fluidic die includes fluidic ejection dies and non-ejecting fluidic dies.

Further, as used in the present specification and in the appended claims, the term “fluidic device” refers to an individual component of a fluidic die that manipulates fluid. The fluidic device includes at least a chamber and an actuator. A particular example of a fluidic device is a fluidic ejection device which refers to an individual component of a fluid ejection die that dispenses fluid onto a surface. The fluidic ejection device includes at least an ejection chamber, an ejector actuator, and an opening.

Further, as used in the present specification and in the appended claims, the term “set” refers to a grouping of fluidic devices. Each group may include fluidic devices that are adjacent one another.

Similarly, as used in the present specification and in the appended claims, the term “zone” refers to a grouping of sets of fluidic devices. Each zone may correspond to one sensor, such as a temperature sensor that indicates a thermal state of that zone.

Further, as used in the present specification and in the appended claims, the term “actuator” refers to an ejecting actuator and/or a non-ejecting actuator. For example, an ejecting actuator operates to eject fluid from the fluid ejection die. A recirculation pump, which is an example of a non-ejecting actuator, moves fluid through the fluid slots, channels, and pathways within the fluidic die.

As used in the present specification and in the appended claims, the term “firing signal” refers to a firing signal as it is received at a particular zone. A firing signal may include multiple pulses. For example a firing signal may include a number of pulses. For example, a firing signal may include a precursor pulse and a firing pulse, among others.

By comparison, an “adjusted firing signal” refers to a firing signal that has been adjusted, i.e., had its properties changed and been delayed, in the zone. This adjusted firing signal is then propagated to each zone on the fluidic die to be further delayed (per set) and adjusted (per zone).

Further, as used in the present specification and in the appended claims, the term “adjust” refers to a change in the physical properties of the firing signal, such things as a magnitude, length, and number of pulses in a firing signal. By comparison, the term “delay” refers to a change in the start time of the firing signal.

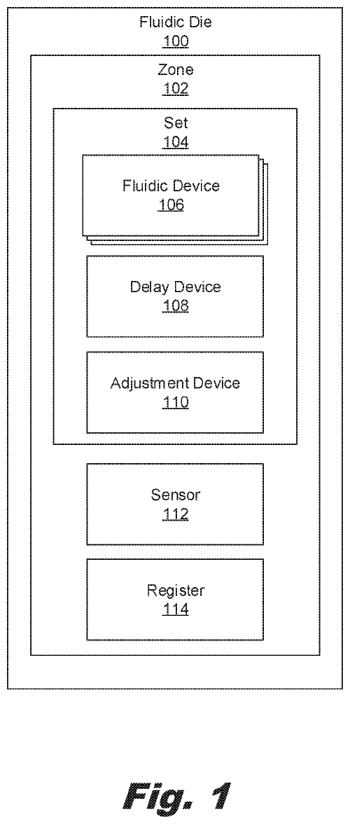

Turning now to the figures, FIG. 1 is a block diagram of a fluidic die (100) for zone-based firing signal adjustment, according to an example of the principles described herein. As described above, the fluidic die (100) is a part of a fluidic system that houses components for ejecting fluid and/or transporting fluid along various pathways. In some examples, the fluidic die (100) is a microfluidic die (100). That is, the channels, slots, and reservoirs on the microfluidic die (100) may be on a micrometer, or smaller, scale to facilitate conveyance of small volumes of fluid (e.g., picoliter scale, nanoliter scale, microliter scale, milliliter scale, etc.). The fluid that is ejected and moved throughout the fluidic die (100) can be of various types including ink, biochemical agents, and/or fusing agents. The fluid is moved and/or ejected via an array of fluidic devices (106). Any number of fluidic devices (106) may be formed on the fluidic die (100).

The fluidic die (100) includes a number of zones (102) with each zone (102) including a grouping of sets (104) of fluidic devices (106). The fluidic device (106) is a component that includes a fluid chamber and a fluid actuator. Fluid held in the fluid chamber is moved via the fluid actuator which is disposed in the fluid chamber. The fluid chamber may take many forms. A specific example of such a fluid chamber is an ejection chamber where fluid is held prior to ejection from the fluidic die (100). In another example, the fluid chamber may be a channel, or conduit through which the fluid travels. In yet another example, the fluid chamber may be a reservoir where a fluid is held.

The fluid actuators work to eject fluid from, or move fluid throughout, the fluidic die (100). The fluid chambers and fluid actuators may be of varying types. For example, the fluid chamber may be an ejection chamber wherein fluid is expelled from the fluidic die (100) onto a surface for example such as paper or a 3D build bed. In this example, the fluid actuator may be an ejector that ejects fluid through an opening of the fluid chamber.

In another example, the fluid chamber is a channel through which fluid flows. That is, the fluidic die (100) may include an array of microfluidic channels. Each microfluidic channel includes a fluid actuator that is a fluid pump. In this example, the fluid pump, when activated, displaces fluid within the microfluidic channel. While the present specification may make reference to particular types of fluid actuators, the fluidic die (100) may include any number and type of fluid actuators.

These fluid actuators may rely on various mechanisms to eject/move fluid. For example, an ejector may be a firing resistor. The firing resistor heats up in response to an applied voltage. As the firing resistor heats up, a portion of the fluid in an ejection chamber vaporizes to generate a bubble. This bubble pushes fluid out an opening of the fluid chamber and onto a print medium. As the vaporized fluid bubble collapses, fluid is drawn into the ejection chamber from a passage that connects the fluid chamber to a fluid feed slot in the fluidic die (100), and the process repeats. In this example, the fluidic die (100) may be a thermal inkjet (TIJ) fluidic die (100).

In another example, the fluid actuator may be a piezoelectric device. As a voltage is applied, the piezoelectric device changes shape which generates a pressure pulse in the fluid chamber that pushes the fluid through the chamber. In this example, the fluidic die (100) may be a piezoelectric inkjet (PIM fluidic die (100). In an example, the actuators are formed as columns or as 2D arrays on the fluidic die (100).

A set (104) may include any number of fluidic devices (106) and a zone (102) may include any number of sets (104). Moreover, a fluidic die (100) may include any number of columns, each column having any number of sets (104).

To fire a fluidic actuator in a fluidic device (106), a firing signal is applied to the actuator. A global firing signal is generated at a controller and may include one or multiple pulses. For example, a firing signal may include a precursor pulse and a firing pulse which are separated in time. The energy supplied to the actuator, and thereby that in part defines the drop weight, may be controlled by the width of the pulses. Other characteristics, such as the magnitude of the pulses, and the quantity of pulses also affect the drop weight.

As described above, any number of characteristics of the fluidic die (100) may change over the length of the fluidic die (100). For example, a temperature of the fluidic die (100) may be greater near its center as opposed to the edges. This temperature gradient, and the other gradients that may exist, can affect uniform fluidic deposition. Accordingly, the fluidic die (100) includes components that compensate for such gradients to ensure uniform fluidic manipulation. Specifically, the fluidic die (100) includes a sensor (108) per zone (102) to detect the characteristic for that zone (102). For example, each zone (102) may include a temperature sensor (108) that detects a temperature at that location. Accordingly, a temperature profile for the fluidic die (100) is generated with measurements per zone (102). With such a temperature profile, the firing signal can be adjusted in each zone (102) such that energy is delivered to each zone (102) to generate a drop having planned characteristics.

As described above, the sensors (108) may be temperature sensors. In one example, the temperature sensor is a diode which is a junction device that measures temperature at a local point. In another example, the temperature sensor may be a resistor which may be a device to measure a temperature at a point, or a serpentine structure that averages temperature along its length, giving an average temperature of the zone (102).

Based on this temperature profile, adjustment values are calculated for each zone (102). That is, a first adjustment value is calculated for a first zone (102) and a second adjustment value is calculated for a second zone (102). These values are calculated by a controller that may be disposed on the fluidic die (100) or off the fluidic die (100) and are passed to the zones (102). Accordingly, each zone (102) includes a register (114) to hold an adjustment value associated with the zone (102). That is, the register (114) holds an adjustment value which indicates how much to adjust a firing signal in that zone (102). This register (114) therefore is a memory storage device for the zone (102).

The zone (102) also includes a number of delay devices (108), specifically a delay device (108) per set (104). The delay devices (108) introduce a temporal delay to the firing signal as it is passed to the set (104). That is, a firing signal is received and delayed at each set (104) within the zone (102). Such a delay is to satisfy fluidic and electrical constraints on a print system. If a large number of fluidic devices (106) within a set (104), zone (102), or fluidic die (100) were actuated at the same time, a current surge may result, which could result in undesirable qualities of fluidic actuation such as non-uniform drops, under-energized actuation etc. Additionally, if too many actuators are actuated simultaneously, the bounds of the fluid delivery system may be exceeded and fluidic performance of the device may be compromised.

The zone (102) also includes multiple adjustment devices (110), specifically an adjustment device (110) per set (104). The adjustment devices (110) generate an adjusted firing signal which accounts for the specific characteristic at that zone (102). For example, a controller receives a sensed characteristic of the zone (102) and determines an adjustment to be made to the firing signal as it passes through that zone (102) based on the received sensed characteristic. The controller then sends the adjustment value to the register (114), which sends the stored adjustment value to the adjustment device (110). The adjustment device (110) then alters the firing signal for that zone (102) based on the adjustment value, This adjustment ensures that the fluidic devices (106) in the zone (102) receive an intended amount of energy to eject fluid drops with an intended weight.

In some examples, adjusting the firing signal may include adjusting a width of the firing signal or adjusting a width of a pulse which forms a portion of the firing signal, Adjusting the width of the firing pulse/signal adjusts the amount of energy delivered. Thus, an increase in temperature may indicate that less energy should be provided to form a particular drop weight. Accordingly, for a zone (102) that is warmer than another, the firing signal may be shortened by a certain amount to ensure that the drop weights between the two zones (102) are the same, in spite of any difference in temperature.

Specifically, the adjustment device (110) generates an adjusted firing signal by relying on this adjustment value, the delayed firing signal for that set (104), and delayed firing signals for other sets (104). That is, different sets (104) have different overall delays such that a wide variety of start times exist for firing signals across the fluidic die (100), A delayed firing signal corresponding to a particular set (104) is passed to multiple other sets (104), and similarly delayed firing signals from multiple other sets (104) are received at the particular set (104). Accordingly, any given adjustment device (110) has multiple input signals, each input signal being a delayed firing signal that is delayed to a different degree. Using logic to combine these signals in different fashions, an adjusted firing signal can be generated that matches a signal defined by the adjustment value. This is done at each zone (102) on the fluidic die (100) such that each zone (102) generates fluid drops having a desired size and weight, notwithstanding the effects of sensed characteristic on that zone (102).

According to a specific example, in a first zone (102) it is desired to extend the firing signal by one delay cycle due to the first zone (102) being cooler than a desired temperature. Accordingly, the first zone's (102) delayed firing signal would be logically OR'ed with the locally delayed firing signal from a subsequent zone (102).

In another example, in the first zone (102) it is desired to extend the firing signal by two delay cycles due to the first zone (102) being cooler than a desired temperature. Accordingly, the first zone's (102) delayed firing signal would be logically OR'ed with the locally delayed firing signal from a third zone (102). As illustrated, adjustments to a firing signal may be made on the fluidic die (100) and may be unique to a particular zone (102) thus resulting in customized and local thermal adjustments to improve print quality. That is, in a first zone (102) near an edge of the fluidic die (100) a particular firing signal may be passed which generates drops of a certain weight. In a second zone (102) an increased temperature in that zone (102) may generate drops of a greater weight. Accordingly, the adjustment devices (110) may shorten the firing signal in that second zone (102) such that drops are generated with the same weight as those generated in the first zone (102) notwithstanding the temperature difference between the two zones (102).

Such a fluidic die (100) accounts for thermal variance, or other variance, across a fluidic die (100) by adjusting the firing signal as it propagates through the different zones (102). By doing so at a zonal level, as opposed to at a fluidic die (100) level, a higher resolution correction can be applied to the fluidic die (100) thus resulting in a fluid ejection that is more accurate to the intended result.

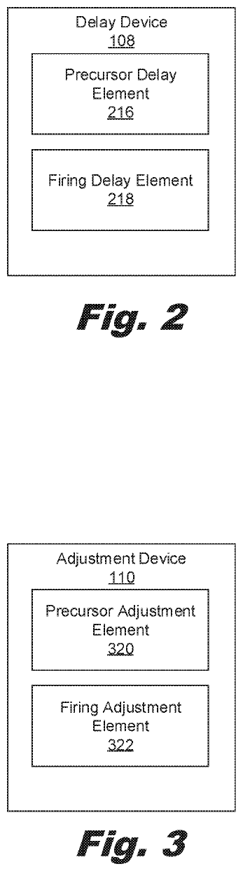

FIG. 2 is a block diagram of a delay device (108) for zone-based firing signal adjustment, according to an example of the principles described herein. In some examples, the firing signal that is received has multiple components. For example, a firing signal may have a precursor pulse and a firing pulse. In this example, the delay device (108) includes multiple elements. First, a precursor delay element (216) delays a precursor pulse of the firing signal. A firing delay element (218) delays a firing pulse of the firing signal.

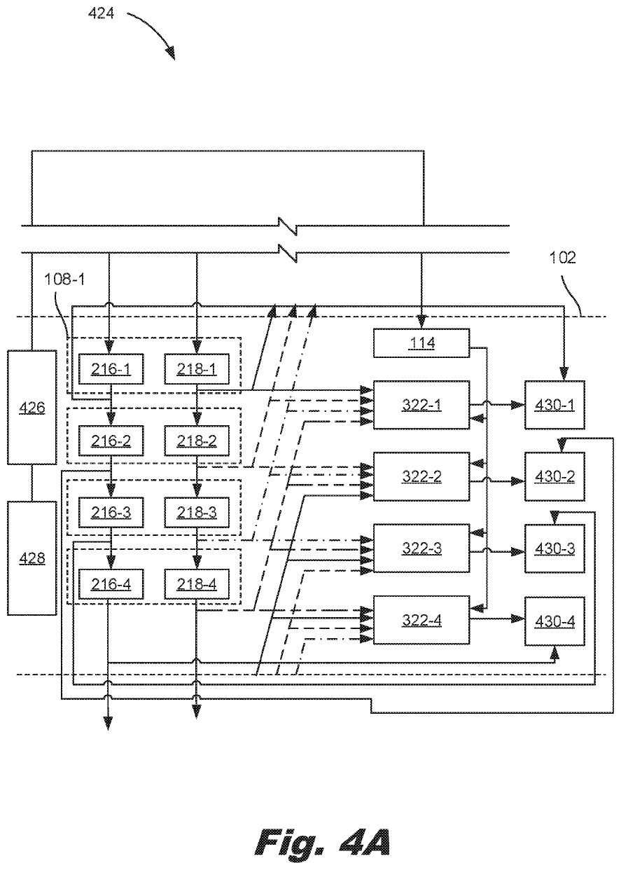

FIG. 3 is a block diagram of an adjustment device for zone-based firing signal adjustment, according to an example of the principles described herein. As described above, in some examples the firing signal that is received has multiple components. In this example, the adjustment device (110) includes multiple elements. First, a precursor adjustment element (320) generates an adjusted precursor pulse. A firing adjustment element (322) generates an adjusted firing pulse.

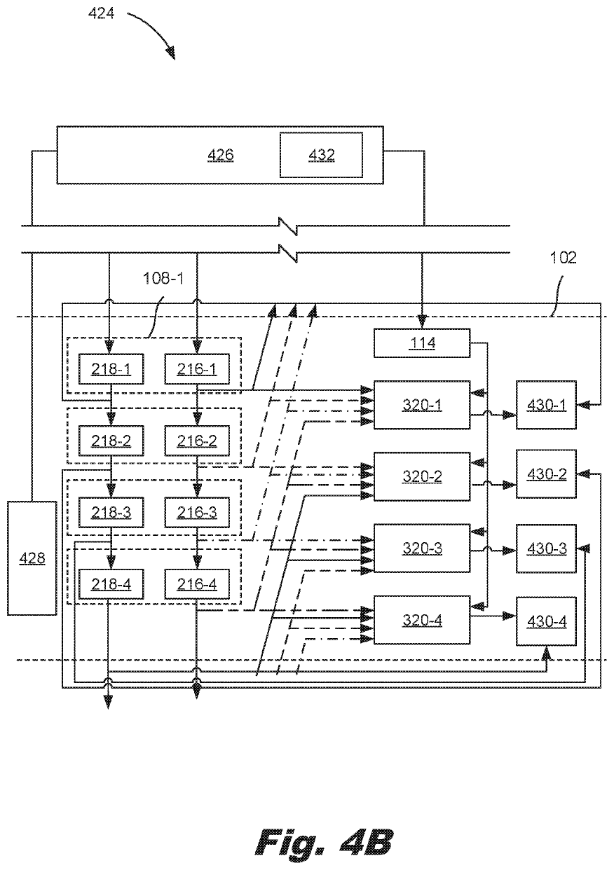

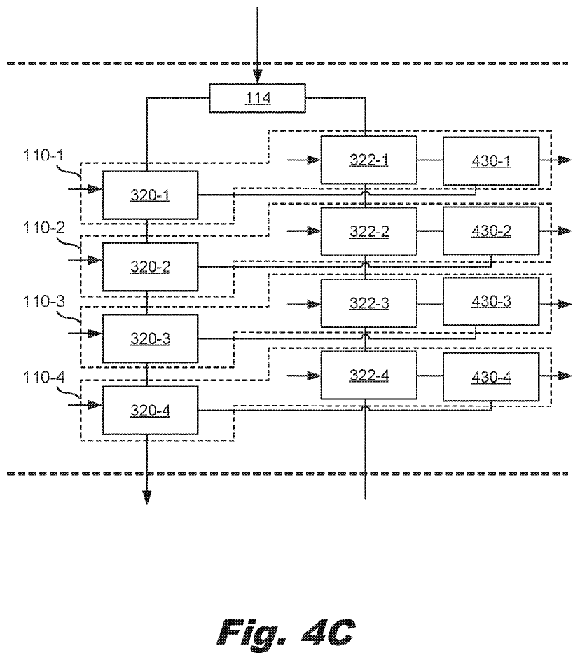

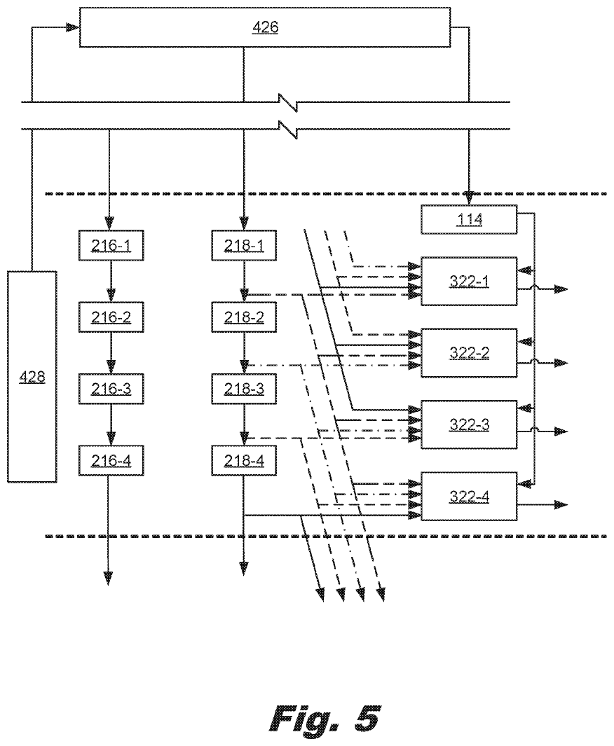

FIGS. 4A-4C are schematic diagrams of a fluidic system (424) for zone-based firing signal adjustment, according to an example of the principles described herein. Specifically, FIG. 4A depicts a portion that delays and adjusts a firing pulse of the firing signal where the controller (426) is per-zone; FIG. 4B depicts a portion that delays and adjusts a precursor pulse of the firing signal where the controller (426) is shared among zones (102); and FIG. 4C depicts the combination of an adjusted firing pulse and an adjusted precursor pulse.

The fluidic system (424) includes a fluidic die (FIG. 1, 100) and a controller (426). As described above, each fluidic die (FIG. 1, 100) is divided into a number of zones (102). For simplicity, FIG. 4A depicts one zone (102), however a fluidic die (FIG. 1, 100) may include any number of zones (102). As described above, each zone (102) includes a number of sets (FIG. 1, 104) of fluidic devices (FIG. 1, 106), which sets (FIG. 1, 104) receive the adjusted firing signals. Also, as described above, each zone (102) includes a sensor (FIG. 1 112). In this specific example, the sensor (FIG. 1, 112) is a temperature sensor (428) that detects a temperature detected at the zone (102).

The fluidic system (216) also includes at least one controller (426) to receive the sensed characteristic and determine a corresponding adjustment value. In some examples, as depicted in FIG. 4A, each zone (102) includes a unique controller (426). When each zone (102) has its own controller (426) to receive a measurement and output a corresponding adjustment value, each zone (102) can be measured and compensated in parallel since each zone (102) has its own measurement block. However, as depicted in other figures, in some examples, the controller (426) may be shared by multiple zones (102).

As described above, the controller (426) of the system (424), being coupled to the temperature sensors (428) of multiple zones (102), takes the sensed temperature for the zones (102) and determines an adjustment value for each zone (102). Such a determination may be based on a lookup table that maps temperature values to a desired energy for a firing pulse. The controller (426) can then determine how to adjust a firing signal at that zone (102) to deliver the desired energy. This adjustment amount is then passed to the register (114) of the zone (102) to which the controller (426) is also coupled. In other words, the outputs from the controller (426) to each register (114) are based on local temperature sensor (428) measurements in each zone (102). Thus, a localized correction can be applied to the sets (FIG. 1, 104) within that zone (102) to ensure a desired drop size. Note that in some examples, the controller (426) is disposed on the fluidic die (FIG. 1, 100) while in other examples, the controller (426) is disposed off of the die and in this case may be multiplexed to multiple fluidic die (FIG. 1, 100) to determine adjustment values for each of the fluidic die (FIG. 1, 100). That is in some examples, the controller (426) is shared by multiple sets zones (102) and a multiplexer couples the controller.

As described above, each zone (102) includes a delay device (108-1) per set (FIG. 1, 104). For simplicity in the figures, a single instance of a delay device (108-1) is indicated with a reference number. In this example, the delay device (108-1) may include multiple delay elements (216, 218). Specifically, each delay device (108) may include a precursor delay element (216) to delay a first pulse, i.e., precursor pulse of the firing signal, and a firing delay element (218) to delay a second pulse, i.e., firing pulse of the firing signal. That is, a first set (FIG. 1, 104) may be coupled to one instance of a precursor delay element (216-1) and one instance of a firing delay element (218-1). Similarly, a second set, third, set, and fourth set (FIG. 1, 104) may correspond to a second instance, third instance, and fourth instance of each of a precursor delay element (216-2, 216-3, 216-4) and a firing delay element (218-2, 218-3, 218-4),

In this example, outputs of either the precursor delay element (216) or the firing delay element (218), or both may be used to extend and/or truncate the respective pulse. For example, as depicted in FIG. 4A, the output of the firing delay elements (218) for a set may be passed to firing adjustment elements (FIG. 3, 322) of that set and other sets to effectuate an adjustment of the corresponding firing pulses. By comparison, as depicted in FIG. 4B, the output of the precursor delay elements (216) for a set may be passed to precursor adjustment elements (FIG. 3, 320) of that set and other sets to effectuate an adjustment of the precursor pulse.

In one example, as depicted in FIG. 4C both the precursor pulse and the firing pulse may be adjusted such that the outputs of both the precursor adjustment elements (FIG. 3, 320) and firing adjustment elements (FIG. 3, 322) may be combined to form the adjusted firing signal. In other words, the adjusted firing signal may include an adjusted precursor pulse (as depicted in FIG. 4B), an adjusted firing pulse (as depicted in FIG. 4A) or both an adjusted precursor pulse and an adjusted firing pulse (as depicted in FIG. 4C). In other words, FIGS. 4A and 4B depict adjusting a firing pulse and a precursor pulse. Any combination of adjusted and unadjusted versions of these pulses may be combined to form the adjusted firing signal. For example, the firing pulse may be adjusted while the precursor pulse is unadjusted, and these may be combined to form the adjusted firing signal. In another example, both the firing pulse and the precursor pulse may be adjusted, and these may be combined to form the adjusted firing signal.

Returning to FIG. 4A, the firing delay elements (218) that are relied on in generating the adjusted firing pulse pass their corresponding delayed firing pulses to at least one of an upstream set (FIG. 1, 104) and a downstream set (FIG. 1, 104). For example, as depicted in FIG. 4A, delayed firing signals originating from a fourth firing delay element (218-4) are passed to the fourth firing adjustment element (322-4), the third firing adjustment element (322-3), the second firing adjustment element (322-2), and the first firing adjustment element (322-1). Doing so allows the adjusted firing signal to be generated, That is, by performing logical combinations of the delayed firing pulses corresponding to a particular set (FIG. 1, 104) and delayed firing pulses corresponding to other sets (FIG. 1, 104) which have a different overall delay, a variety of adjusted firing signals may be generated, which can be combined with a precursor pulse, either adjusted or not, to generate the adjusted firing signal. In other words, the firing adjustment element (322) is provided multiple inputs that can be combined in different fashions to generate an adjusted firing pulse. The inputs that are combined are selected based on the adjustment value stored in the register (114) which value is passed to the firing adjustment elements (322). For example, if at a first zone (102) it is desired to extend a firing pulse of a firing signal by one delay element, each delayed firing pulse at a set can be logically OR'ed with a delayed firing pulse at the immediately adjacent set (FIG. 1, 104). An example of such generation is provided in connection with FIG. 9.

As described above, each delayed firing pulse can be passed to upstream or downstream adjustment elements. FIG. 4A illustrates inputs to the firing adjustment elements (322) from downstream delayed firing pulses which effectuates an extension of a falling edge of the firing pulse when logically OR'ed with another delayed firing pulses or a truncation of a rising edge of the firing pulse when logically AND'ed with another delayed firing pulse. That is, in the example depicted in FIG. 4A, each firing adjustment element (322) can 1) adjust a falling edge of the firing pulse by 1) extending the falling edge by logically OR'ing the delayed firing pulse corresponding to the set (FIG. 1, 104) with at least one delayed firing pulse received from a downstream set and/or 2) truncating the rising edge of the delayed firing pulse signal by logically AND'ing the delayed firing pulse corresponding to the set with at least one delayed firing pulse received from a downstream set. The adjustment elements (322) include varying types of logic including an and-or-invert cell.

FIG. 4A also depicts the combine logic (430) that is included in each adjustment device (FIG. 1, 110). The combine logic (430) combines the precursor pulse (whether adjusted or not) with the firing pulse (whether adjusted or not) to generate the adjusted firing signal.

In the example depicted in FIG. 4B, the controller (426) is shared by multiple zones (102). Doing so may make a more efficient use of circuit space. In this example, the controller (426) includes a multiplexer (432) to couple the controller (426) to a particular zone (102) such that a temperature may be received and an adjustment value written to a register (114).

FIG. 4B depicts an adjustment to the precursor pulse. That is, the precursor pulse as it passes through the precursor delay element (216-1) is passed to precursor adjustment elements (320) to effectuate an extension or truncation of the precursor pulse. Specifically, the precursor delay elements (216) that are relied on in generating the adjusted precursor pulse pass their corresponding delayed precursor pulses to at least one of an upstream set (FIG. 1, 104) and a downstream set (FIG. 1, 104). For example, as depicted in FIG. 4B, a delayed precursor pulse originating from a fourth precursor delay element (216-4) is passed to the fourth precursor adjustment element (320-4), the third precursor adjustment element (320-3), the second precursor adjustment element (320-2), and the first precursor adjustment element (320-1). Doing so allows the adjusted firing signal to be formed. That is, by performing logical combinations of the delayed precursor pulse corresponding to a particular set (FIG. 1, 104) and delayed precursor pulses corresponding to other sets (FIG. 1, 104) which have a different overall delay, a variety of adjusted precursor pulses may be generated, which can be combined with a firing pulse, either adjusted or not, to generate the adjusted firing signal. In other words, the precursor adjustment element (320) is provided multiple inputs that can be combined in different fashions to generate an adjusted precursor pulse. The inputs that are combined are selected based on the adjustment value stored in the register (114) which value is passed to the precursor adjustment elements (320). For example, if at a first zone (102) it is desired to extend a precursor pulse of a firing signal by one delay element, each delayed precursor pulse at a set can be logically OR'ed with a delayed precursor pulse at the immediately adjacent set (FIG. 1, 104).

As described above, each delayed precursor pulse can be passed to upstream or downstream adjustment elements (320). FIG. 4B illustrates inputs to the precursor adjustment elements (320) from downstream delayed precursor pulses which effectuates an extension of a falling edge of the precursor pulse when logically OR'ed with another delayed precursor pulse or a truncation of a rising edge of the precursor pulse when logically AND'ed with another delayed precursor pulse. That is, in the example depicted in FIG. 4B, each precursor adjustment element (320) can 1) extend a falling edge of the precursor pulse by logically OR'ing the delayed precursor pulse corresponding to the set (FIG. 1, 104) with at least one delayed precursor pulse received from a downstream set and/or 2) truncate the rising edge of the delayed precursor pulse by logically AND'ing the delayed precursor pulse corresponding to the set with at least one delayed precursor pulse received from a downstream set.

FIG. 4B also depicts the combine logic (430) that is included in each adjustment device (FIG. 1, 110). The combine logic (430) combines the precursor pulse (whether adjusted or not) with the firing pulse (whether adjusted or not) to generate the adjusted firing signal.

FIG. 4C is a schematic diagram of a zone (FIG. 1, 102) for zone-based firing signal adjustment, according to an example of the principles described herein. As described above, either the precursor pulse, the firing pulse, or both may be adjusted. FIG. 4A depicted an adjustment of the firing pulse and FIG. 4B depicted an adjustment of the precursor pulse. In some examples, the circuitry depicted in FIGS. 4A and 4B could be combined, with the controller (FIG. 4, 426) positioned in the location indicated in either of FIGS. 4A and 4B. FIG. 4C depicts the combination of these adjusted pulses to generate an adjusted firing signal. For simplicity, the inputs into each adjustment element (320, 322) are indicated with a single arrow.

As described above, the adjustment device (110) may include multiple adjustment elements. Specifically, a first adjustment device (110-1) includes a precursor adjustment element (320-1) corresponding to the generation of an adjusted precursor pulse. The first adjustment device (110-1) also includes a firing adjustment element (322-2) corresponding to the generation of an adjusted firing pulse. In this example, the adjustment device (110) also includes combine logic (430) to logically combine the adjusted firing pulse and the adjusted precursor pulse to generate an adjusted firing signal. In one example, the combine logic (430) may include circuitry to logically OR the adjusted firing pulse with the adjusted precursor pulse. Each of the second adjustment device (110-2), third adjustment device (110-3), and fourth adjustment device (110-3) include similar circuitry for generating adjusted firing signals for different sets (FIG. 1, 104).

FIG. 5 is a schematic diagram of a fluidic system for zone-based firing signal adjustment, according to an example of the principles described herein. As described above, each delayed fire signal can be passed to upstream or downstream adjustment elements. FIGS. 4A and 4B illustrate inputs to the firing adjustment elements (322) coming from downstream delayed firing pulses which effectuates an extension of a falling edge of the firing pulse when logically OR'ed with another delayed firing pulse or a truncation of a rising edge of the firing pulse when logically AND'ed with another delayed firing pulse. FIG. 5 illustrate inputs to the firing adjustment element (322) coming from upstream delayed firing pulses which effectuates a truncation of the falling edge of the firing pulse when AND'ed with another delayed firing pulse or an extension of a rising edge when logically OR'ed with another delayed firing pulse. Note that while FIG. 5 depicts downstream propagation of firing pulses, similar circuitry may be implemented to propagate precursor pulses downstream.

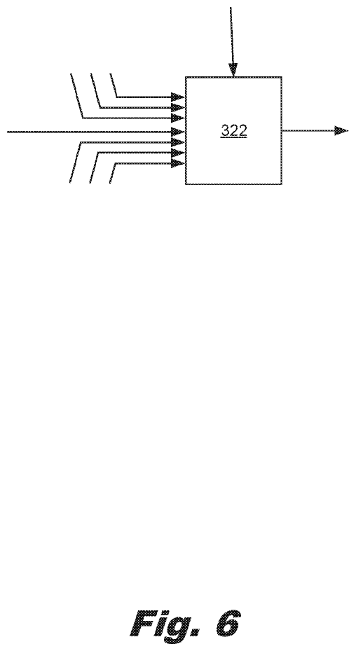

FIG. 6 is a schematic diagram of an adjustment element for zone-based firing signal adjustment, according to an example of the principles described herein. Specifically, FIG. 6 depicts a firing adjustment element (322), however similar principles apply to the precursor adjustment element (320).

As described above, delayed pulses from sets (FIG. 1, 104) can be passed upstream or downstream. FIGS. 4A and 4B depict passing delayed pulses upstream and FIG. 5 depicts passing delayed firing pulses downstream, FIG. 6 depicts a firing adjustment element (322) that receives input signals from both upstream and downstream delay elements. In this example, the firing adjustment element (322) includes logic to both logically OR different delayed pulses and to logically AND different pulses. Accordingly, in this example, the firing adjustment element (322) can extend and/or truncate both a rising edge and a falling edge of a corresponding pulse. Note that in each example depicted in FIGS. 4C-6, the degree to which a pulse can be adjusted is defined by the number of inputs at an adjustment element with more inputs allowing for greater adjustment of length.

Note that while FIG. 5 depicts downstream and upstream propagation of firing pulses, similar circuitry may be implemented to propagate precursor pulses downstream and upstream.

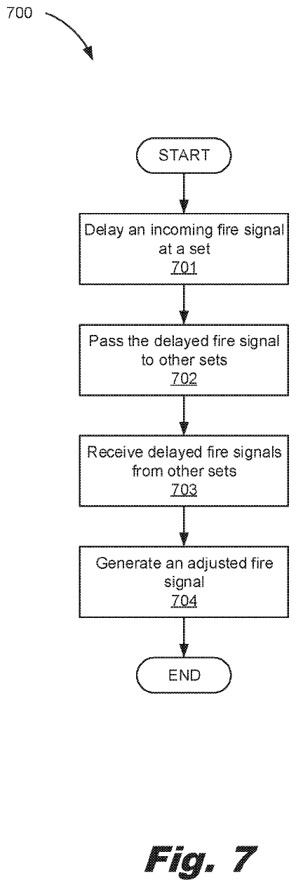

FIG. 7 is a flow chart of a method (700) for zone-based firing signal adjustment, according to an example of the principles described herein, According to the method (700) an incoming firing signal is delayed (block 701) at a set. That is, the delay device (FIG. 1, 108) associated with a set (FIG. 1, 104) receives a firing signal and imposes a temporal delay on it so to offset the execution of the different firing signals. Doing so reduces a maximum current on the fluidic die (FIG. 1, 100) to prevent current surges.

In the case where the firing signal has multiple pulses such as a precursor pulse and a firing pulse, the delay (block 701) may include delaying both the precursor pulse and the firing pulse via separate delay chains.

The delayed signals, or the delayed pulses, can be passed (block 702) to other sets (FIG. 1, 104). That is, a delay device (FIG. 1, 108) associated with a particular set (FIG. 1, 104) may delay the firing signal, pass it to its corresponding set (FIG. 1, 104) and also pass it to other sets (FIG. 1, 104). In some cases, the delayed pulses can be passed to upstream and/or downstream sets (FIG. 1, 104). In so doing, multiple inputs are provided to an adjustment device (FIG. 1, 110). These inputs are used to craft an adjusted firing signal. Moreover, as described above, a delayed precursor pulse may be sent separate from a delayed firing pulse. The set (FIG. 1, 104) may receive (block 703) delayed firing signals from other sets (FIG. 1, 104). Following these operations, each set (FIG. 1, 104) has multiple inputs, one from its corresponding delay device (FIG. 1, 108), and other inputs from the delay devices (FIG. 1, 108) corresponding to other sets (FIG. 1, 104).

With this information, the adjustment devices (FIG. 1, 110) generate (block 704) an adjusted fire signal based on the adjustment value, the delayed fire signal corresponding to the set (FIG. 1, 104) and at least one delayed firing signal from another set (FIG. 1, 104). That is, the adjustment value may indicate a degree to which a firing signal is to be adjusted. The scale to which a firing signal is adjusted is defined in part by the amount of delay between adjacent sets (FIG. 1, 104). In the example depicted in FIGS. 4A-4C, the firing signal may be delayed at each zone (FIG. 1, 102) by one delay unit, where one delay unit corresponds to the delay imposed by a delay device (FIG. 1, 108). That is, the firing signal may be extended by one delay unit, reduced by one delay unit, or maintained the same. The delay unit of a delay device (FIG. 1, 108) may be selected based on the application. For example, the delay unit may be 20 nanoseconds. Accordingly, in the example depicted in FIGS. 4A-4C, the firing signal at a particular zone (FIG. 1, 102) may be shortened by 20 nanoseconds, lengthened by 20 nanoseconds, or maintained the same. Other delay units may be implemented as well.

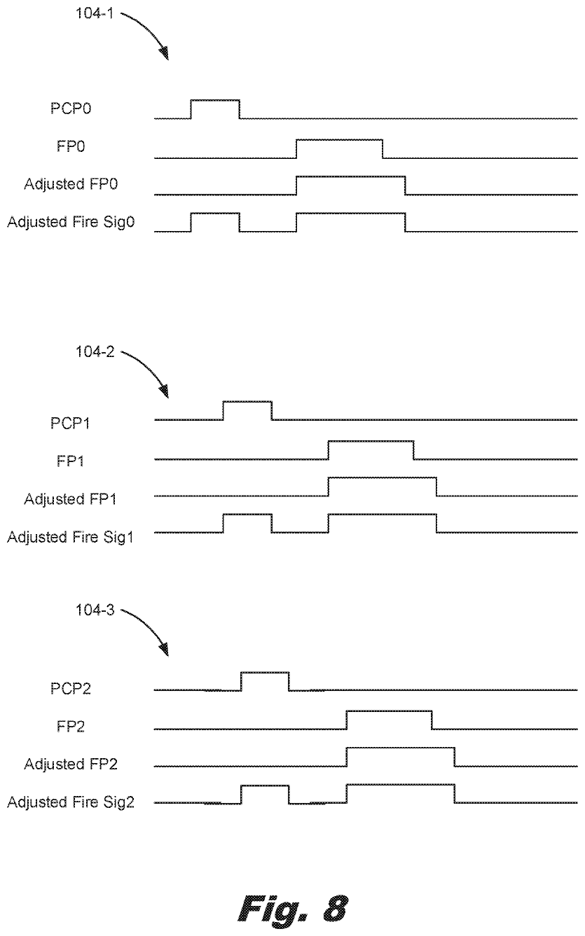

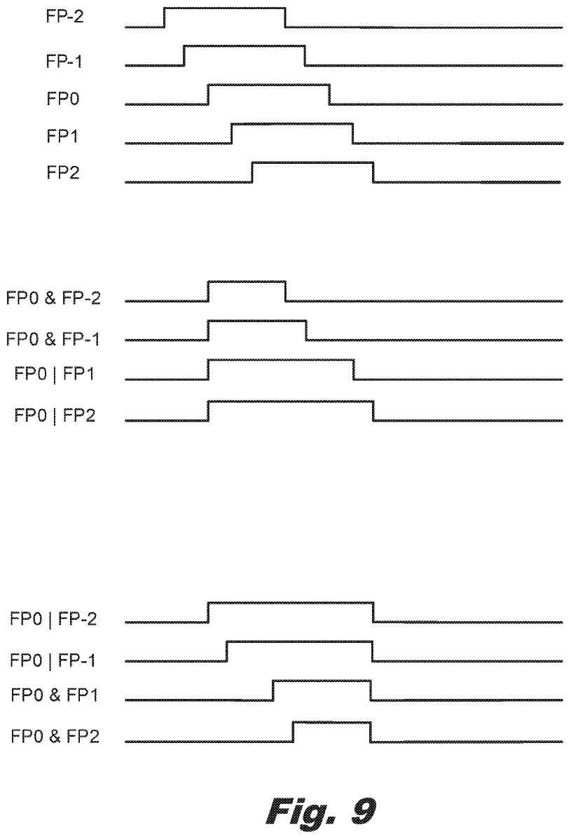

While FIGS. 4A-4C depict adjusting the firing signal by a single delay unit, some adjustment devices (FIG. 1, 110) may be able to adjust the firing signal by more delay units. For example, an adjustment device (FIG. 1, 110) may be able to adjust the firing signal by one delay unit in either direction and/or two delay units in either direction. To do so, additional inputs to the adjustment elements (FIG. 3, 320, 320) would be implemented. An example of generating (block 704) an adjusted firing pulse is described in connection with FIGS. 8 and 9.

FIG. 8 is an example of generated adjusted fire pulses, according to an example of the principles described herein. FIG. 8 depicts generated adjusted firing signals that include an adjusted firing pulse and an unadjusted precursor pulse. However, similar principles apply to generating an adjusted precursor pulse which may be combined with an adjusted or unadjusted firing pulse. Specifically, FIG. 8 depicts adjustments in a first set (104-1), a second set (104-2), and a third set (104-3).

At a first set (104-1), a precursor pulse, PCP0, and a firing pulse, FP0, are received. At some point in time, the controller (FIG. 4, 426) receives a sensor (FIG. 1, 112) reading from a sensor (FIG. 1, 112) in the zone (FIG. 1, 102) that includes the sets (104-1, 104-2, 104-3). This reading indicates that more energy should be used to produce a desired drop weight within the zone (FIG. 1, 102). Accordingly, the adjustment device (FIG. 1, 110) of the set (104) extends the firing pulse by one delay unit. This is indicated in FIG. 8 as the increased length of the adjusted firing pulse, Adjusted_FP0. As the adjusted firing signal propagates through the zone (102) it is delayed at each subsequent set (104-2, 104-3).

Via the firing adjustment element (FIG. 3, 322), a falling edge of the firing pulse, FP0, is extended, for example by logically OR'ing it with a downstream delayed firing pulse to generate an adjusted fire pulse, Adjusted FP0. The adjusted firing pulse, Adjusted_FP0, is then combined with the precursor pulse, PCP0, to generate an adjusted fire signal, Adjusted_Fire_Sig0. Note that in this example, the temperature at the zone (FIG. 1, 102) may be lower than the reference temperature. This is evidenced by the extension of the firing pulse, FP0, which extension provides more energy. That is, a cooler temperature may use more energy to deliver a particular drop weight. Accordingly, to maintain a desired drop weight, the firing signal is extended by an amount to ensure that the drop weight in the zone (FIG. 1, 102) matches a desired drop weight.

At a second set (104-2), a precursor pulse, PCP1, and a firing pulse, FP1, are delayed. This is indicated by the precursor pulse, PCP1, for the second set (104-2), and the firing pulse, FP1, for the second set (104-2) being offset in their initialization time from the previous set (104-1).

Note that in the second set (104-2), the firing pulse is adjusted similarly. That is, the trailing edge of firing pulse, FP1, in the second set (104-2) is extended, by logically OR'ing it with a downstream delayed firing pulse to generate an adjusted fire pulse, Adjusted_FP1. This is then combined with the precursor pulse, PCP1, for the second set (104-2), to generate an adjusted fire signal, Adjusted Fire_Sig1.

Similarly, at a third set (104-3), a precursor pulse, PCP2, and a firing pulse, FP2, are delayed. This is indicated by the precursor pulse, PCP2, for the third set (104-3), and the firing pulse, FP2, for the third set (104-3) being offset in their initialization time from the previous set (104-2).

Note that in the third set (104-3), the firing pulse is adjusted similarly. That is, the trailing edge of firing pulse, FP2, in the third set (104-3) is extended, by logically OR'ing it with a downstream delayed firing pulse to generate an adjusted fire pulse, Adjusted_FP2. This is then combined with the precursor pulse, PCP2, for the third set (104-3), to generate an adjusted fire signal, Adjusted_Fire_Sig2.

FIG. 9 is an example of adjusted firing pulses, according to an example of the principles described herein. Specifically, in this example a base firing pulse, FP0, for a particular set (FIG. 1, 104) is to be adjusted. In this example, FP-1 indicates a firing pulse for an immediately upstream set (FIG. 1, 104), FP-2 indicates a firing pulse for an even further upstream set (FIG. 1, 104), FP1 indicates a firing pulse for an immediately downstream set (FIG. 1, 104), and FP2 indicates a firing pulse for an even further downstream set (FIG. 1, 104). FIG. 9 clearly indicates the offset nature of these firing pulses by their respective difference in their initialization points in the clock cycle. These signals are input into the firing adjustment element (FIG. 3, 322) corresponding to the base set (FIG. 1, 104).

As described above, by logically OR'ing or logically AND'ing one of the other firing pulses with the base firing pulse, FP0, an adjusted firing pulse can be generated. For example, FP-1 and FP0 could be logically AND'ed to trim a falling edge and to generate an adjusted firing pulse that is one delay unit shorter than the base firing pulse, FP0. Similarly, FP-2 and FP0 could be logically AND'ed together to trim the falling edge even more and to generate an adjusted firing pulse that is 2 delay units shorter than the base firing pulse, FP0. By comparison, by combining the base firing pulse, FP0, with downstream pulses the falling edge ban be extended. For example, FP1 and FP0 could be logically OR'ed together to extend the falling edge and to generate an adjusted firing pulse that is one delay unit longer than the base firing pulse, FP0, Similarly, FP2 and FP0 could be logically OR'ed together to extend the falling edge even more and to generate an adjusted firing pulse that is 2 delay units longer than the base firing pulse, FP0.

While specific reference is made to adjusting a falling edge, similar operations could be carried out to adjust a rising edge. For example, FP-1 and FP0 could be logically OR'ed to extend a rising edge and to generate an adjusted firing pulse that is one delay unit longer than the base firing pulse, FP0. Similarly, FP-2 and FP0 could be logically OR'ed together to extend the rising edge even more and to generate an adjusted firing pulse that is 2 delay units longer than the base firing pulse, FP0. By comparison, by combining the base delayed firing pulse with downstream delayed firing pulses the rising edge ban be shortened. For example, FP1 and FP0 could be logically AND'ed together to trim the rising edge and to generate an adjusted firing pulse that is one delay unit shorter than the base firing pulse, FP0. Similarly, FP2 and FP0 could be logically AND'ed together to trim the rising edge even more and to generate an adjusted firing pulse that is 2 delay units shorter than the base firing pulse, FP0.

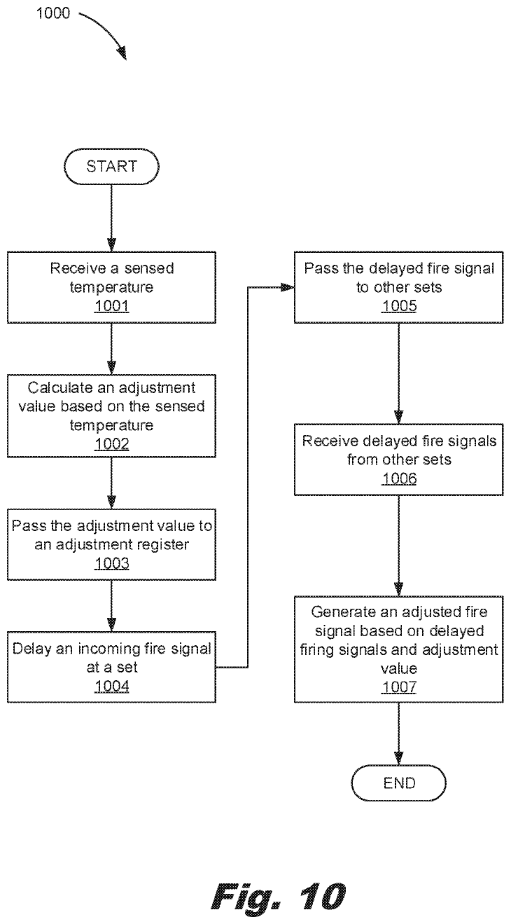

FIG. 10 is a flow chart of a method (1000) for zone-based firing signal adjustment, according to an example of the principles described herein. According to the method (1000), a sensed temperature for a zone (FIG. 1, 102) is received (block 1001). Specifically, a controller (FIG. 4, 426) of a fluid system (FIG. 4, 424) receives (block 1001) a sensed temperature from a sensor (FIG. 1, 112) disposed on a fluidic die (FIG. 1, 100) and associated with that zone (FIG. 1, 102). That is, each zone (FIG. 1, 102) includes a sensor (FIG. 1, 112), such as a temperature sensor (FIG. 4, 428). While specific reference is made to a temperature sensor (FIG. 4, 428), other types of sensors (FIG. 1, 112) may be used such as an electrical sensor to determine a degree of parasitic loss along the firing chain. As described above, the sensed characteristic is local to a zone (FIG. 1, 102). That is, each zone (FIG. 1, 102) sends sensed characteristics specific to that zone (FIG. 1, 102), to the controller (FIG. 4, 426).

Based on the sensed characteristics, the controller (FIG. 4, 426) calculates (block 1002) an adjustment value to apply to the firing signals at each zone (FIG. 1, 102). That is, for each zone (FIG. 1, 102), the controller (FIG. 4, 426) determines how much the firing signal in the zone (FIG. 1, 102) should be adjusted relative to an original firing signal. That is, as has been described the temperature of a portion of a fluidic die (FIG. 1, 100) can alter the drop size for a particular firing energy. The adjustment value accounts for the temperature and adjusts the energy delivered by the firing signal to ensure a uniform drop weight. Such adjustments may include adjusting a length of the firing signal pulses. Accordingly, the adjustment value may be indicate a length adjustment value.

As increased die temperature results in a larger drop weight for a given energy, reducing the energy for a warmer zone (FIG. 1, 102) would result in a same size drop, notwithstanding the change in temperature. Accordingly, the adjustment value may be calculated (block 1002) such that the drop weight of the different zones notwithstanding any difference in temperature.

This adjustment value is then passed (block 1003) to a corresponding adjustment register (FIG. 1, 114) such that the value can be used as a guide in logically combine delayed pulses to generate the adjusted firing signal.

Then at the zone (FIG. 1, 102), an incoming fire signal is delayed (block 1004) and passed (block 1005) to other sets (FIG. 1, 104) while delayed signals from other sets (FIG. 1, 104) are received (block 1006). Based on the received signals and the adjustment value, an adjusted fire signal is generated (block 1007). Thus, a firing signal customized for a particular zone (FIG. 1, 102) is generated which ensures that fluid drops having a desired weight are actually generated. These steps may be done as described above in connection with FIG. 7.

In summary, using such a fluidic die 1) provides for the identification of any characteristic gradient that may exist across the fluidic die; 2) compensates for the characteristic gradient, or any offset from a base value, based on localized sensing systems; 3) relies on simple operations to determine an adjustment value; 4) enables parallel sensing and adjustment; 5) occupies a small circuit area; 6) provides self-contained thermal accommodation; and 7) is relatively low cost. However, the devices disclosed herein may address other matters and deficiencies in a number of technical areas.

What is claimed is:

1. A fluidic die, comprising:
a number of zones, each zone comprising:
a number of sets, each set comprising a number of fluidic devices, each fluidic device comprising a fluid chamber and a fluid actuator disposed in the fluid chamber;
a sensor to sense a characteristic of the zone;
a register to hold an adjustment value which indicates how much to adjust a firing signal in the zone;
a delay device per set to delay the firing signal at a corresponding set; and
an adjustment device per set to generate an adjusted firing signal based on:
the adjustment value;
a delayed firing signal corresponding to the set; and
at least one delayed firing signal received from another set, wherein delayed firing signals from different sets are time shifted relative to one another.

2. The fluidic die of claim 1, wherein:
the sensor is a temperature sensor; and
the adjustment value is based on a sensed temperature.

3. The fluidic die of claim 1, wherein each delay device passes a corresponding delayed fire signal to at least one of:
multiple upstream sets; and
multiple downstream sets.

4. The fluidic die of claim 1, wherein the adjustment device adjusts the firing signal to match the adjustment value stored in the register.

5. The fluidic die of claim 1, wherein:
each delay device comprises:
a precursor delay element is to delay a precursor pulse of the firing signal;
a firing delay element is to delay a firing pulse of the firing signal;
each adjustment device comprises:
a precursor adjustment element to generate an adjusted precursor pulse;
a firing adjustment element to generate an adjusted firing pulse; and
the fluidic die further comprises combine logic to combine the adjusted precursor pulse and the adjusted firing pulse.

6. The fluidic die of claim 5, wherein an adjustment element adjusts a falling edge of a corresponding pulse by at least one of:
extending the corresponding pulse by logically OR'ing a delayed pulse corresponding to the set with at least one delayed pulse received from a downstream delay device; and
truncating the pulse by logically AND'ing a delayed pulse corresponding to the set with at least one delayed pulse received from an upstream delay device.

7. The fluidic die of claim 5, wherein an adjustment element adjusts a rising edge of a corresponding pulse by at least one of:
extending the corresponding pulse by logically OR'ing a delayed pulse corresponding to the set with at least one delayed pulse received from an upstream delay device; and
truncating the pulse by logically AND'ing a delayed pulse corresponding to the set with at least one delayed pulse received from a downstream delay device.

8. A fluidic system, comprising:
a fluidic die comprising:
a number of zones, each zone comprising:
a number of sets, each set comprising a number of fluidic devices;
a temperature sensor; and
a register to hold an adjustment value which indicates how much to adjust a firing signal in the zone;
a delay device per set to delay the firing signal at a corresponding set; and
an adjustment device per set to generate an adjusted firing signal based on:
the adjustment value;
a delayed firing signal corresponding to the set; and
at least one delayed firing signal received from another set, wherein delayed firing signals from different sets are time shifted relative to one another; and
at least one controller:
coupled to temperature sensors and registers for multiple zones; and
to determine the adjustment value for each zone.

9. The fluidic system of claim 8, wherein the controller is disposed on the fluidic die.

10. The fluidic system of claim 8, wherein the controller is off-die.

11. The fluidic system of claim 8, wherein:
the at least one controller comprises a single controller shared by multiple zones; and
the single controller comprises a multiplexer to selectively couple the single controller to a particular zone.

12. The fluidic system of claim 8, wherein:
the at least one controller comprises multiple controllers; and
each controller is uniquely paired with a zone.

13. A method comprising,
delaying an incoming fire signal at a delay device associated with a set, the set comprising multiple fluidic devices;
passing a delayed fire signal to multiple other sets;
receiving at the set, delayed firing signals from other sets; and
generating, at an adjustment device for the set, an adjusted firing signal based on:
the adjustment value;
a delayed firing signal corresponding to the set; and
at least one delayed firing signal from the other sets, wherein delayed firing signals from different sets have different overall delays.

14. The method of claim 13, wherein:
the firing signal comprises at least a first pulse and a second pulse; and
delaying the incoming firing signal comprises adjusting at least one of the first pulse and the second pulse.

15. The method of claim 13, further comprising:
receiving a sensed temperature at a sensor corresponding to the zone;
calculating the adjustment value based on the sensed temperature; and
passing the adjustment value to an adjustment register.
